(19) United States
(12) Patent Application Publication
(10) Pub. No.: US 2008/0248206 A1
(43) Pub. Date: Oct. 9, 2008

(54) Embossing Rollers with Surface Treatment, Method for the Production Thereof and Embossing Unit Comprising said Rollers

(75) Inventors: Emilio Della Torre, Varese (IT); Fabio Conforti, Lucca (IT)

Correspondence Address: BREINER & BREINER, L.L.C., P.O. BOX 320160, ALEXANDRIA, VA, 22320-0160, US

(73) Assignee: Perini Engraving S.r.1. Via per Mugnano, 815, Lucca (IT)

(21) Appl. No.: 11/579,395

(22) PCT Filed: May 3, 2005
(86) PCT No.: PCT/IT2005/00255

§ 371 Date: Dec. 7, 2006

(30) Foreign Application Priority Data
May 5, 2004 (IT) FI2004A000105

(51) Int. Cl. B05D 3/10; B32B 37/14

(52) U.S. Cl. 427/331; 156/553

(57) ABSTRACT

Disclosed is an embossing roller (3) comprising an essentially cylindrical surface provided with a plurality of protuberances (3P), with non-stick surface treatment (51, 53), comprising an anchoring layer (51) having a porous structure and a non-stick material (53) filling the surface porosities of the anchoring layer.

### TECHNICAL FIELD

The present invention relates to innovations in the field of embossing rollers, in particular although not exclusively to produce embossing rollers intended for processing paper, especially tissue paper, intended for the production of toilet paper, kitchen towel, handkerchiefs and the like.

Specifically, the invention relates to embossing rollers, methods for the production thereof and embossing units comprising said rollers.

### PRIOR ART

In the processing of web or sheet materials, an embossing process is frequently provided, wherein the material is subjected to mechanical processing causing breakage of the fibers and permanent deformation of the material to obtain special effects both of an aesthetic and functional nature. In particular, in the field of converting of the so-called tissue paper, intended to produce rolls of toilet paper, rolls of kitchen towel, paper handkerchiefs and napkins or the like, embossing is used as an operation to decorate the product and to improve its physical properties, in particular to increase volume, softness and capacity to absorb liquids.

Embossing units are frequently embossing-laminating units, wherein the sheet materials are not only embossed, but also bonded to one another to obtain multi-ply products. Bonding is usually obtained by glue applied to the protrusions of the embossed product.

The embossing units can have various configurations and can be more or less complex. Simpler embossing units are characterized by a cylinder made of a hard material, typically steel, with a cylindrical surface provided with protrusions or protuberances. This cylinder cooperates with a smooth cylinder coated in a yielding material, typically rubber or the like. The web material, composed of one or more plies, is fed through two rollers pressed against each other so that the protrusions or protuberances of the steel cylinder penetrate the yielding coating of the pressure roller and consequently cause deformation of the web material fed into the nip between the rollers.

In some cases the two cylinders or rollers cooperating with each other are both made of hard material, such as steel, and mesh with each other, in the sense that the protuberances produced on one cylinder enter cavities produced on an opposed cylinder. Also in this case the web material fed into the nip between the two cylinders is permanently deformed. However, contrary to what occurs when using rubber cylinders, in this case the two cylinders can cooperate without being pressed against each other, as deformation of the web material is obtained by interlocking, that is, by geometrical interpenetration of the protrusions in the cavities of the opposed cylinder.

In more complex embossing units, more than two rollers are provided to emboss two or more plies and join them to one another by applying glue.

Embossing laminating units of this type have, for example, two embossing cylinders each cooperating with a respective pressure roller coated in a yielding material, typically rubber, with a smooth surface. Two plies are embossed separately between each embossing roller and the corresponding pressure roller. In the nip between the embossing rollers two embossed plies are joined and laminated after having applied a glue to the protuberances produced on one or other or on both plies. In some cases lamination takes place downstream of the nip between the embossing rollers, pressing the two plies against each other against the protuberances of one of the embossing cylinders by means of a laminating roller.

Other embossing-laminating devices are in any case configured to perform embossing operations on several plies and lamination by means of gluing.

Examples of embossing units in various configurations are described in the U.S. Pat. No. 6,578,617, in U.S. Pat. No. 6,470,945, in European patent n. 1.075.387, in European patent n. 370.972, in publication WO-A-99/41064, in the publication WO-A-99/44814, and in numerous other patents pertaining to the same technological field.

When processing paper, especially tissue paper, a great deal of dust is produced, formed of fibers which detach from the base material. This dust tends to soil the embossing rollers, especially when they also operate in combination with gluing units used to apply glue for reciprocal joining of the plies forming the material delivered from the embossing unit.

Therefore, embossing rollers require periodic cleaning operations which can also be particularly complex when the paper dust adheres to the roller as a result of glue seeping through the paper and soiling the surface of the roller to cause adhesion of the paper fibers and dust.

### OBJECTS AND SUMMARY OF THE INVENTION

The object of the present invention is to produce an embossing roller which overcomes or reduces the aforesaid drawbacks.

Another object of the invention is to provide a procedure to produce an embossing roller which overcomes or reduces the aforesaid drawbacks.

Yet another object of the invention is to produce an embossing unit with rollers which are less subject to becoming soiled and consequently reduce or solve the aforesaid problems relative to the need for frequent cleaning operations.

In substance, according to a first aspect, the invention relates to an embossing roller comprising an essentially cylindrical surface provided with a plurality of protuberances, characterized by a non-stick surface treatment. With this treatment adhesion of any glue that may seep through the paper (or other material to be embossed), treated by the embossing roller is made more difficult and this consequently reduces the tendency of paper dust or fibers to adhere to the surface of the roller.

According to a particularly advantageous aspect of the invention, the embossing roller has an anchoring layer of the non-stick treatment, combined with a non-stick material. The anchoring layer advantageously has a porous structure. In this way the non-stick material is anchored to the surface of the embossing roller filling the surface porosities of the anchoring layer. In this way, a stable non-stick surface treatment is obtained, which is consequently also resistant to long operating times of the roller.

According to an advantageous embodiment of the invention, an anchoring layer comprising or composed of a ceramic material is applied to the surface of the embossing roller provided with the embossing protuberances. This ceramic layer can be a ceramic oxide of a metal, such as chromium oxide, titanium oxide, aluminum oxide, zirconium oxide or a combination of the aforesaid materials. This anchoring layer can be applied to the base material forming the thickness in which the protuberances of the embossing roller are engraved according to a suitable technique.

Alternatively to metal oxide, the anchoring layer may be composed of or comprise a metal carbide, such as chromium carbide, tungsten carbide or mixtures thereof. Alternatively, the anchoring layer can be composed of a metal superalloy, based on chrome, nickel, cobalt or equivalent materials.

However, it has been found that layers based on ceramic metal oxide and in particular based on aluminum oxide are particularly advantageous, in view of the high porosity of these materials, and consequently the particularly effective anchoring exerted thereby on the non-stick material.

The non-stick material can be a fluoropolymer based resin, Teflon®, a product based on silicon oils, or other suitable materials having a non-stick effect.

According to an advantageous embodiment the anchoring layer is applied to the cylindrical surface of the roller so that the thickness thereof is greater In the cavities than on the frontal surface and on the sides of the protuberances produced on said cylindrical surface. For example and in particular, the thickness can be greatest in the cavities and minimum on the sides. For example, the thickness of the anchoring layer can be in the range of 40-60 micrometers on the bottom of the cavities, in the range of 40-50 micrometers on the frontal, or radially outermost, surface of the protuberances of the roller.

The embossing roller can be produced in different materials, and can also have a composite structure. For example, it can be composed of machining steel, nitridable stainless steels, composite materials based on resin and carbon fiber or glass fiber; plastic or rubber materials, such as ebonite, PVC, polyethylene or the like. It would also be possible to use composite rollers with a core and an interchangeable outer sleeve made of steel, composite materials, plastics or rubbers as indicated above. In this case the non-stick treatment is applied to the cylindrical surface of the interchangeable sleeve.

It would also be possible to produce rollers with a core or body faced with a layer made of alloys using spray metallizing processes or the like, such as copper, nickel, zinc, steel and alloys thereof. It would also be possible to use materials applied by submerged arc welding or other procedures.

In general, the invention relates to an embossing roller with surface protuberances produced in any way, with any base material of the roller, provided that it has suitable characteristics of mechanical strength for the use for which it is intended and is susceptible to receive said non-stick treatment.

The protuberances provided on the roller and to which the non-stick treatment is applied can be obtained with various techniques, such as engraving by chip-forming machining, using a hob or the like. Alternatively, or in combination, engraving techniques using mechanical pressure (mechanical engraving), chemical etching, photographic exposure or laser paint removal and subsequent chemical removal of the base material of the surface to be engraved could also be used. Engraving with laser systems according to drawing are also possible.

In general, the invention is not limited to the type of engraving technique used to produce the protuberances, as said technique can be chosen according to the nature of the material of the embossing cylinder or roller and as a function of the forms and dimensions of the protuberances to be produced. For example, protuberances with a simple geometric form can be easily obtained by engraving by means of chip removal or mechanical pressure, while protuberances of complex form, intended in particular for operations to decorate the paper material, can be more easily obtained by means of laser engraving systems or chemical etching.

In general, according to a particular aspect, the invention relates to a method to produce an embossing roller wherein embossing protuberances are produced on an essentially cylindrical surface, characterized in that a non-stick treatment is applied to the essentially cylindrical surface provided with protuberances.

According to a particular embodiment of the method according to the invention, an anchoring layer is applied to the surface engraved and provided with protuberances, and a non-stick material is subsequently applied to said anchoring layer. The anchoring layer can be composed of one of the aforesaid materials and have a more or less porous structure to guarantee stable anchoring of the non-stick material which fills, entirely or in part, the surface porosities of the anchoring layer.

According to a particular embodiment of the method of the invention, the engraved surface of the roller is subjected to an activation phase to improve the grip of the anchoring layer. The activation phase can comprise a treatment to increase surface roughness, such as a sandblasting treatment.

According to a particular embodiment of the method of the invention, the anchoring layer (which can also have anti-wear characteristics) is applied by means of a plasma spray procedure or by means of a combustion spray procedure.

The non-stick material can advantageously be applied to the anchoring layer by means of spraying, coating or another suitable method.

Further advantageous characteristics and embodiments of the roller according to the invention, of the embossing unit employing said roller and of the production method are indicated in the appended claims.

### BRIEF DESCRIPTION OF THE DRAWINGS

The invention shall be better understood by following the description and accompanying drawing, which shows a non-limiting practical embodiment of the finding. In the drawing:

FIGS. 1 and 2 show possible configurations of embossing-laminating units in which the present invention can be advantageously employed; and

FIGS. 3A-3C schematically show the succession of processes in a greatly enlarged schematic section of a protuberance of an embossing roller.

### DETAILED DESCRIPTION OF THE INVENTION

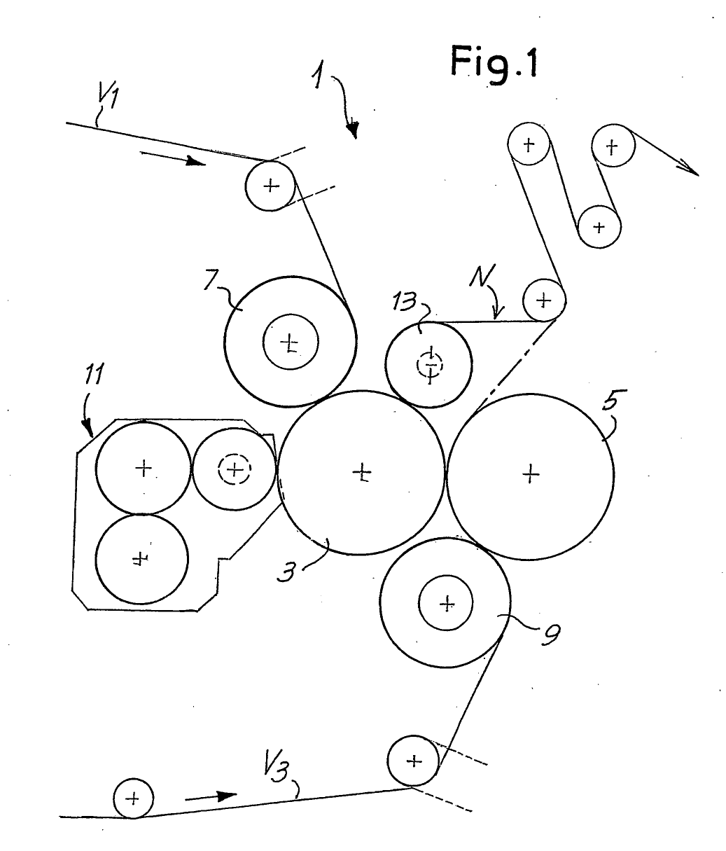

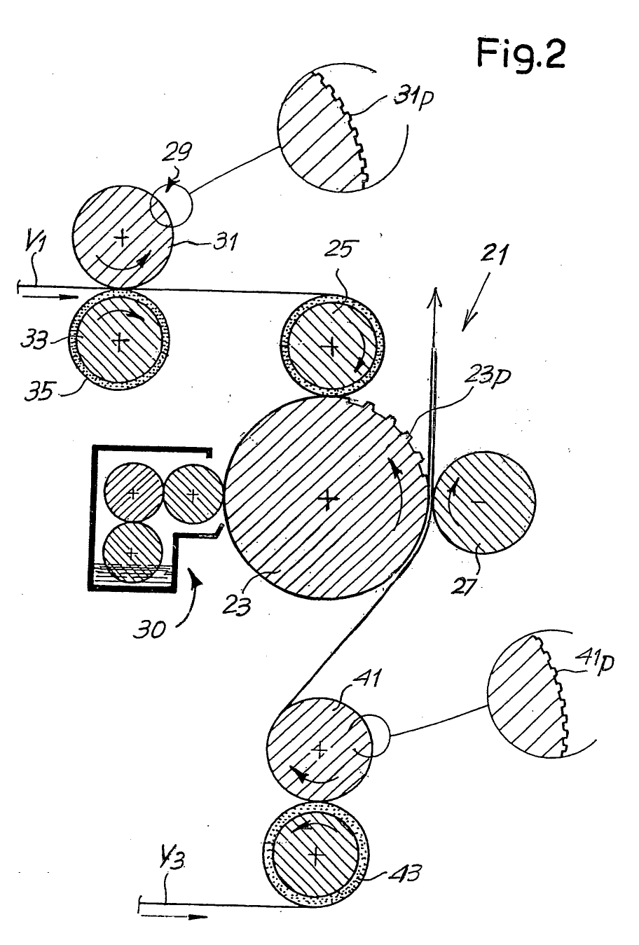

FIGS. 1 and 2 schematically show two embossing-laminating units of different configuration wherein rollers with a non-stick treatment according to the invention can be used. It must be understood that the embossing-laminating units in FIGS. 1 and 2 are only two examples of possible machinery to which embossing rollers treated according to the invention can be advantageously applied.

With reference to FIG. 1, the embossing-laminating unit, indicated as a whole with 1, comprises a first embossing roller 3 and a second embossing roller 5 with parallel axes forming therebetween a nip. The embossing rollers 3 and 5, which are provided on the surface thereof with protuberances obtained by means of engraving using any of the available techniques, each cooperate with a corresponding pressure roller 7 and 9. The pressure rollers 7 and 9 are coated in a yielding material, such as plastic or rubber, and have a smooth outer surface.

Two plies V1 and V3 of web material, such as tissue paper, are fed into the nips between the rollers 3 and 7 and between the rollers 5 and 9 respectively. In this way the two plies V1 and V3 are embossed as a result of the pressure exerted by the embossing rollers 3 and 5 against the yielding surfaces of the rollers 7 and 9. Glue is applied to the protuberances-produced on the ply V1 by the protrusions of the embossing roller 3, by means of a gluing unit 11, of known type and represented schematically in the figure. The two plies are laminated to each other in the nip between the embossing rollers 3 and 5 by pressing them at the level of corresponding protrusions or protuberances of the rollers 3 and 5. Alternatively, the two rollers 3 and 5 can be disposed with their protuberances staggered, that is, with the protuberances of the roller 5 opposing the cavities between the protuberances of the roller 3, or distanced from one another and in any case without reciprocal contact between the points. In this case the two plies V1 and V3 are not laminated between the rollers 3 and 5, but between the roller 3 and a secondary laminating roller 13.

Notwithstanding the embossing and laminating technique used, a multi-ply web material N is delivered from the embossing unit, composed of the two plies V1 and V3, embossed and glued to each other. Each ply can be in turn composed of several layers.

In the embodiment in FIG. 2 the embossing-laminating unit, indicated herein with 21, comprises a main embossing roller 23 which cooperates with a pressure roller 25 with a coating in a yielding material, such as rubber, and having an essentially smooth surface. Also cooperating with the embossing roller 23, provided with protrusions 23P, is a laminating roller 27 with a smooth surface, rigid or yielding, in any case advantageously more rigid than the cylindrical surface of the pressure roller 25.

A first ply of web material V1 is fed about the pressure roller 25 through the nip formed by this roller and by the embossing roller 23. Before passing through this nip the web material V1 passes through a secondary embossing unit, indicated as a whole with 29, and composed of an embossing cylinder or roller 31 provided with protuberances or protrusions 31P and cooperating with a pressure roller 33 coated in rubber or another yielding material.

A second ply of web material V3 is fed into the nip between the embossing roller 23 and the laminating roller 27. In this nip the ply V3 is glued against the embossed ply V1, to which, by means of a gluing unit 30, a glue has been applied on the protrusions or protuberances produced by the protuberances 23P of the embossing roller 23.

The ply V3 can also advantageously have been pre-embossed by means of an embossing roller 41 provided with protrusions 41P and cooperating with a pressure roller 43 coated in a yielding material, such as rubber or plastic.

The configurations of these embossing-laminating units illustrated by way of examples are described in greater detail in WO-A-99/41'064 and WO-A-99/44814, which should be referred to for further details.

The embossing rollers 3, 5, 23 and optionally also the embossing rollers 31 and 41 can be produced with a non-stick treatment according to the invention.

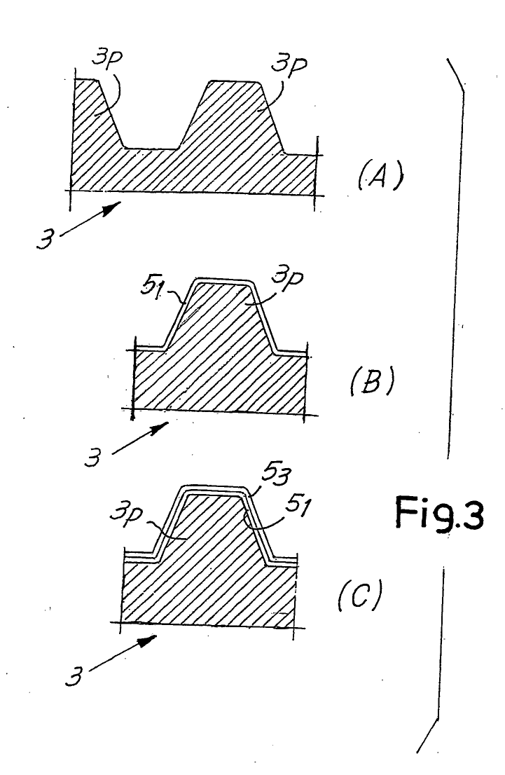

FIGS. 3A-3C schematically show a greatly enlarged local section of a protuberance of any one of these embossing rollers prior to the non-stick treatment, in an intermediate phase of the treatment (FIG. 3B) and after completion of the treatment (FIG. 3C). In practice, the non-stick material (Teflon® or the like) which is applied to the rough surface of the anchoring layer fills the microporosities of the anchoring layer (which also has the function of increasing the resistance to wear of the roller) and also forms a continuous coating layer or film. However, during the first hours of use of the roller the layer of non-stick material in excess is gradually removed, especially at the level of the surface portions with the most exposures, although the microporosities of the anchoring layer remain filled, providing the roller with an adequate non-stick effect.

As can be seen by comparing FIGS. 3A to 3C, the side surface of the embossing roller, generically indicated in these figures with 3 and provided with protrusions generically indicated with 3P, after treatment (FIG. 3C) is provided with an anchoring layer 51 which coats the entire surface of the protuberances and of the cavities between adjacent protuberances. More specifically, the anchoring layer 51 coats the bottom of the cavities between adjacent protuberances 3P, the sides of the protuberances 3P and the frontal surfaces of said protuberances. The thickness of the anchoring layer 51 is advantageously variable in the various surface areas of the roller. More specifically, this thickness is greater on the bottom of the cavities between protuberances 3P and lesser on the sides and on the frontal surfaces of the protuberances 3P.

The anchoring layer 51 is produced, for example, in chromium oxide, which is a ceramic material with high porosity. The porosity is filled at least partially with a non-stick material 53, applied for example by spraying and subsequently fixed by baking in the oven, or by any other suitable means, to the anchoring layer 51. The non-stick material 53 also forms a coating layer on the entire surface of the anchoring layer 51. By penetrating the porosities of the latter, the non-stick material 53 remains fastened to the surface of the embossing cylinder or roller 3 and withstands the action of abrasion exerted thereon by the material being embossed.

The roller 3, as previously indicated, can be made of any material suitable to withstand embossing stresses. These can be extremely high, especially when the roller operates in an embossing-laminating unit of the type illustrated in FIGS. 1 and 2. However, it would also be possible for the stresses on the roller to be greatly reduced, for example, when it is part of a simple embossing unit, such as a roller which is part of a pair of male and female rollers, wherein it cooperates with the opposed roller provided with cavities and wherein the two rollers mesh with each other without particular reciprocal pressure stresses.

In a possible embodiment, the overall treatment cycle, with a steel embossing cylinder or roller 3, is schematically as follows:
manufacture of the steel roller by means of known technique;
any preliminary heat treatments, followed by any grinding or pre-grinding treatments;
engraving and creation of the protuberances 3P with a known technique, such as chip removal using a hob, laser engraving, chemical etching, mechanical engraving or with a combination of these methods;
softening of the engraving, with consequent rounding of the engraving edges, for example by brushing;
elimination of processing residues, residues of oils or other treatment liquids by sandblasting processes, pickling of various type, treatment in the oven or other processes;
surface activation by means of sandblasting or other procedure to increase surface roughness;
application of the ceramic layer by plasma spraying or the like;
application, by spraying, painting or other methods, of the non-stick material, typically a fluoropolymer based resin (Teflon®);
oven baking;
any finish according to drawing.

It must be understood that the processing cycle indicated above is provided purely by way of example and can vary according to the type of material used, especially to produce the base cylinder.

The embossing roller thus treated, provided with a non-stick layer anchored by means of the ceramic layer, for example based on ceramic metal oxides, drastically reduces the tendency of glue and/or paper debris to accumulate on the active surface of the embossing roller, eliminating or greatly reducing the need for cleaning operations during processing or between processing cycles of the embossing or embossing-laminating device in which the roller is inserted.

It is understood that the drawing merely shows an example provided purely as a practical embodiment of the invention, which may vary in forms and arrangements without however departing from the scope of the concept on which the invention is based.

1. An embossing roller comprising an essentially cylindrical surface provided with a plurality of protuberances, characterized by a non-stick surface treatment.

2. Embossing roller as claimed in claim 1, characterized by an anchoring layer combined with a non-stick material.

3. Embossing roller as claimed in claim 2, characterized in that said anchoring layer has a porous structure, and in that said non-stick material at least partially fills the porosities of said anchoring layer.

4. Embossing roller as claimed in claim 2 or 3, characterized in that said anchoring layer comprises a ceramic material.

5. Embossing roller as claimed in claim 4, characterized in that said anchoring layer comprises a ceramic oxide of a metal.

6. Embossing roller as claimed in one or more of the previous claims, characterized by a base thickness wherein said protuberances are at least partially produced, coated by an anchoring layer associated with a non-stick material.

7. Embossing roller as claimed in claim 5, characterized in that said metal oxide is chosen from the group comprising: chromium oxide, titanium oxide, aluminum oxide, zirconium oxide, or a combination thereof.

8. Embossing roller as claimed in one or more of the previous claims, characterized in that said anchoring layer is a layer comprising a metal carbide.

9. Embossing roller as claimed in claim 8, characterized in that said metal carbide is chosen from the group comprising: chromium carbide, tungsten carbide, or mixtures thereof.

10. Embossing roller as claimed in one or more of the previous claims, characterized in that said anchoring layer is a metal superalloy based on chrome, nickel or cobalt.

11. Embossing roller as claimed in one or more of the previous claims, characterized in that said surface treatment comprises a non-stick material chosen from the group comprising: Teflon®; fluoropolymer based resins; silicon oils.

12. Embossing roller as claimed in one or more of the previous claims, characterized by an anchoring layer applied to the cylindrical surface of said roller, wherein the thickness of said anchoring layer is greater in the cavities between protuberances and lesser on the sides of the protuberances.

13. Embossing roller as claimed in claim 12, wherein the thickness of said anchoring layer on the frontal surface of the protuberances is equal to or less than the thickness in the cavities between protuberances, but greater than on the sides of the protuberances.

14. Embossing roller as claimed in one or more of the previous claims, characterized in that it has at least one cylindrical metal outer portion, whereon said protuberances are produced and whereon an anchoring layer and a non-stick treatment are present.

15. Embossing unit comprising at least a first and a second roller cooperating with each other, wherein at least one of said rollers is produced according to one or more of claims 1 to 14.

16. Embossing unit as claimed in claim 15, comprising at least one roller as claimed in one or more of claims 1 to 10 cooperating with at least one smooth pressure roller, coated in an elastically yielding material.

17. Embossing unit as claimed in claim 15 or 16, characterized in that it comprises a glue dispenser and means to join plies of embossed web material to one an other by gluing and lamination.

18. A method for the production of an embossing roller, wherein embossing protuberances are produced on an essentially cylindrical surface, characterized in that a non-stick treatment is applied to the essentially cylindrical surface provided with protuberances.

19. Method as claimed in claim 18, characterized in that an anchoring layer is applied to the essentially cylindrical surface provided with protuberances and a non-stick material is applied to said anchoring layer.

20. Method as claimed in claim 19, characterized in that an anchoring layer with a porous structure is applied and that said non-stick material is applied by at least partially filling the porosities of said anchoring layer.

21. Method as claimed in claim 19 or 20, characterized in that said anchoring layer comprises a ceramic material.

22. Method as claimed in claim 21, characterized in that said anchoring layer comprises a ceramic oxide of a metal.

23. Method as claimed in claim 22, characterized in that said anchoring layer comprises a metal oxide chosen from the group comprising: chromium oxide, titanium oxide, aluminum oxide, zirconium oxide, or a combination thereof.

24. Method as claimed in one or more of claims 18 to 21, characterized in that said anchoring layer is a layer comprising a metal carbide.

25. Method as claimed in claim 24, characterized in that said metal carbide is chosen from the group comprising: chromium carbide, tungsten carbide or combinations thereof.

26. Method as claimed in one or more of claims 18 to 21, characterized in that said anchoring layer is a layer comprising a metal superalloy based on chrome, nickel or cobalt.

27. Method as claimed in one or more of claims 18 to 26, characterized in that said non-stick treatment involves the application of a non-stick material chosen from the group comprising: Teflon®; fluoropolymer based resins; silicon oils.

28. Method as claimed in one or more of claims 18 to 27, characterized in the phases of:
engraving an essentially cylindrical surface and producing thereon a plurality of protuberances;
activating the engraved surface;
applying an anchoring layer to the activated surface;
applying a non-stick material to said anchoring layer.

29. Method as claimed in claim 28, characterized in that said activation phase of the engraved surface comprises a treatment to increase the surface roughness.

30. Method as claimed in claim 28 or 29, characterized in that the activation phase of the engraved surface comprises sandblasting.

31. Method as claimed in one or more of claims 18 to 30, characterized in that an anchoring layer is applied by means of a plasma spray or by means of combustion spray procedure.

32. Method as claimed in one or more of claims 18 to 30, characterized in that said non-stick material is applied by means of spraying.

33. Method as claimed in one or more of claims 19 to 32, wherein said anchoring layer is produced with a greater thickness in the cavities between protuberances and a lesser thickness on the sides of the protuberances.

34. Method as claimed in claim 33, wherein said anchoring layer is produced on the frontal surface of the protuberances with a thickness equal to or less than the thickness in the cavities between protuberances, but greater than on the sides of the protuberances.
